(19) United States
(12) Patent Application Publication
(10) Pub. No.: US 2011/0101951 A1
(43) Pub. Date: May 5, 2011

(54) Zero-Voltage-Switching Self-Driven Full-Bridge Voltage Regulator

(75) Inventors: Zhiliang Zhang, Nanjing (CN); Yan-Fei Liu, Kingston (CA)

(73) Assignees: Zhiliang Zhang, Kingston (CA); Yanfei Liu, Kingston (CA)

(21) Appl. No.: 12/610,097

(22) Filed: Oct. 30, 2009

(51) Int. Cl. G05F 3/08

(52) U.S. Cl. 323/305

(57) ABSTRACT

non-isolated full bridge (FB) converters have self-driven synchronous rectifier (SR) MOSFETs in the current doubler rectifier (CDR). The gate terminals of the SR MOSFETs are connected to the bridge leg midpoints of the FB converter. The primary side of the FB converter shares the same ground of the secondary side, which provides the gate drive path for the SRs. The asymmetrical control featuring zero-voltage-switching (ZVS) capability is applied to the two bridge legs of the FB converter respectively. This creates the right gate drive voltage waveforms for the SRs. The energy of the leakage inductance of the transformer is used to achieve SR gate energy recovery. High gate drive voltages can be used to reduce the on-resistance of SRs and the conduction loss. In this way, no additional gate driver circuitry is needed for the SRs compared to the conventional external drive circuitry for SRs. In this invention, the above features provide high conversion efficiency with high switching frequency. This can help to achieve high power density and fast dynamic response accordingly. The invented power circuits are suitable to low voltage and high current application.

### FIELD OF THE INVENTION

This invention relates generally to voltage regulators. In particular, this invention relates to voltage regulators with gate energy recovery capability and extended duty cycle, for high efficiency and fast dynamic response applications.

### BACKGROUND OF THE INVENTION

As microprocessor technology develops, there are increasing demands on voltage regulator (VR) performance. In particular, microprocessors require VRs with low output voltage and high output current, due to high power consumption of the microprocessors. To meet the strict transient requirements [1] and achieve high power density on the mother board, the switching frequency of VRs has recently moved into the megahertz (MHz) range [2]-[5].

Multiphase buck converters are popular for 12 V VRs, however, such buck converters suffer from an extremely low duty cycle, which increases switching losses and the reverse recovery loss of the body diode of the power switches significantly. More importantly, it has been noted that the parasitic inductance, especially the common source inductance, has a substantial propagation effect during the switching transition and thus further increases the switching loss [6, 7]. Furthermore, the excessive gate driver losses also become a penalty at MHz frequencies, especially for the synchronous rectifier (SR) MOSFETs with high total gate charge [8]. Therefore, frequency-dependent losses become one of the barriers to pushing the switching frequency even higher.

In order to extend the extremely low duty cycle, a tapped inductor buck converter was proposed in [9]. A non-isolated half-bridge (NHB) converter with extended duty cycle was proposed in [10, 11] and similarly, buck-type dc-dc converters utilizing an autotransformer were proposed in [12]. For forward, push-pull, half-bridge topologies with autotransformers, though the duty cycle is extended, the power MOSFETs are still under hard-switching conditions, which results in high switching losses at high frequency (>1 MHz).

A phase-shift buck converter featuring zero-voltage-switching (ZVS) and reduced SR conduction loss was proposed in [13]. Furthermore, an improved self-driven 12 V VR topology was proposed based on a phase-shift buck (PSB) converter to recover the gate drive loss of the synchronous MOSFETs [14]-[16]. This topology achieves very high efficiency and is suitable for VR applications. However, this self-driven converter circuit uses four control MOSFETs all having floating grounds, and external level-shift drive circuits are needed for them. Though the drive scheme proposed in [14] uses a simple level-shift driver, it has several drawbacks: 1) the drive path goes though the synchronous MOSFETs, which increases the parasitic inductance, especially common source inductance, resulting in a significant increase in turn off loss at MHz frequencies; 2) the drive voltage goes negative and the gate energy is dissipated completely through the resistive path; and 3) oscillation of the drain-to-source voltage of the SR MOSFETs may induce drain-source voltage oscillation of the control MOSFETs.

A current tripler isolated dc-dc converter was proposed for a 48 V input power pod to reduce the SR conduction loss in [17]. Though asymmetrical control was used for the control MOSFETs for the primary side of the transformer, the high gate drive loss of the SR MOSFETS was not recovered by the control strategy and gate drive transformer. The current tripler was extended to a self-driven 12 V VR topology in [14]-[16]; however, the control scheme used to achieve the current tripler cannot recover SR gate driver energy.

### SUMMARY OF THE INVENTION

The non-isolated full bridge (FB) converters described herein include ZVS, self-driven capability, gate energy recovery, reduced voltage stress across the SR MOSFETs, and duty cycle extension. These features improve the converter efficiency significantly and achieve high switching frequency and high power density, as well as fast dynamic response.

According to one aspect there is provided a voltage regulator, comprising: a control stage including one or more primary windings of at least one transformer and plurality of control switches connected in a full bridge configuration; and a rectifier stage comprising a current multiplier including one or more secondary windings of the at least one transformer and plurality of rectifier switches; wherein output points of the control stage are connected together through one or more primary windings of the at least one transformer; wherein output points of the rectifier switches are connected together through one or more secondary windings of the at least one transformer.

In one embodiment, each output point of the control stage may be connected directly to a gate of a rectifier switch. In another embodiment, each output point of the control stage may be connected to a device, and the device connected to a gate of a rectifier switch. Each device may be selected from a capacitor, an inductor, a diode, a zener diode, a schottky diode, a resistor, and a combination thereof.

In one embodiment the transformer has one primary winding and one secondary winding, and the current multiplier is a current doubler. Another embodiment may include one transformer having three primary windings and three secondary windings, where the current multiplier is a current tripler. Another embodiment may include three transformers, each transformer having a primary winding and a secondary winding, where the current multiplier is a current tripler. Another embodiment may include one transformer having four primary windings and four secondary windings, where the current multiplier is a current quadrupler. Another embodiment may include four transformers, each transformer having a primary winding and a secondary winding, where the current multiplier is a current quadrupler.

A second aspect provides a current-source gate drive circuit for driving first and second control switches of a full bridge leg, comprising: (A) a first input terminal for receiving an input voltage; a first switch and a second switch connected in series at a first node; a diode having a first terminal connected to the input terminal and a second terminal connected to the drain of the first switch; a series circuit including a first inductor and a first capacitor connected between the first node and the second terminal of the diode; and a third capacitor connected in parallel with the first switch and the second switch; wherein a source of the second switch is connected to a point between the first control switch and the second control switch, and the first node is connected to the gate of the first control switch; and (B) a second input terminal for receiving an input voltage; a third switch and a fourth switch connected in series at a second node, a drain of the third switch being connected to the second input terminal; a series circuit including a second inductor and a second capacitor connected between the second node and the second input terminal; wherein a source of the fourth switch is connected to circuit ground, and the second node is connected to the gate of the second control switch. In one embodiment the first inductor and the second inductor may be integrated.

A third aspect provides a voltage regulator as described above, further comprising the current-source gate drive circuit as described above for one or more legs of the full bridge.

According to a fourth aspect there is provided a method of operating a voltage regulator, comprising: connecting a plurality of control switches in a full bridge configuration with one or more primary windings of at least one transformer in a control stage; providing a rectifier stage comprising a current multiplier including one or more secondary windings of the at least one transformer and plurality of rectifier switches; connecting output points of the control stage together through one or more primary windings of the at least one transformer; and connecting output points of the rectifier switches together through one or more secondary windings of the at least one transformer.

The method may include connecting each output point of the control stage directly to a gate of a rectifier switch. The method may include connecting each output point of the control stage to a device, and connecting the device to the gate of a rectifier switch. The device may be selected from a capacitor, an inductor, a diode, a zener diode, a schottky diode, a resistor, and a combination thereof.

The method may include operating each leg of the full bridge of the control stage with asymmetrical control. The method may include operating at least one leg of the full bridge as a current-source driver to drive the rectifier switches. The method may include using leakage inductance of the transformer to operate the current source driver.

### BRIEF DESCRIPTION OF THE DRAWINGS

For a better understanding of the invention, and to show more clearly how it may be carried into effect, embodiments of the invention will be described below, by way of example, with reference to the accompanying drawings, wherein:

FIG. 1 is a schematic diagram of a ZVS self-driven non-isolated full bridge voltage converter according to one embodiment;

FIG. 2 shows key waveforms of the embodiment of FIG. 1;

FIG. 3 is a schematic diagram of a ZVS self-driven full bridge voltage regulator with reduced gate drive voltage using series capacitors;

FIG. 4 is a schematic diagram of a ZVS self-driven full bridge voltage regulator with reduced gate drive voltage using Zener diodes;

FIGS. 5(A) and 5(B) show key waveforms of the turn-on and turn-off transitions, respectively, of the SR MOSFET Q₆ of the embodiment of FIG. 1;

FIG. 6 is a schematic diagram of a ZVS self-driven full bridge voltage regulator with reduced body diode conduction;

FIG. 7 shows simulation results of the embodiment of FIG. 6, comparing reduction of the body diode conduction time without (FIG. 7(A)) and with (FIG. 7(B)) Lₖ₁ and Lₖ₂ (Vᵢₙ=12 V, Vₒ=1.2 V, Iₒ=50 A, fₛ=1 MHz, Lₖ₁=Lₖ₂=100 nH);

FIG. 8 is a schematic diagram of a ZVS self-driven full bridge voltage regulator with reduced gate drive voltage and reduced body diode conduction, according to another embodiment;

FIG. 9 is a schematic diagram of a ZVS self-driven full bridge voltage regulator with reduced gate drive voltage and reduced body diode conduction, according to another embodiment;

FIG. 10 is a schematic diagram showing two non-isolated ZVS self-driven FB converters connected in parallel;

FIG. 11 is a schematic diagram of a three phase non-isolated ZVS self-driven full bridge converter with a current tripler rectifier;

FIG. 12 shows key waveforms of the circuit of FIG. 11;

FIG. 13 is a schematic diagram of a four phase non-isolated ZVS self-driven full bridge converter with a current quadrupler rectifier;

FIG. 14 shows key waveforms of the circuit of FIG. 13;

FIG. 15 is a schematic diagram of an n-phase non-isolated ZVS self-driven full bridge converter with a multiple stage rectifier;

FIG. 16 is a schematic diagram of an n-phase non-isolated ZVS self-driven full bridge converter with a multiple stage rectifier and direct energy transfer;

FIG. 17 is a schematic diagram of a three-phase non-isolated ZVS self-driven full bridge converter with a current doubler rectifier and direct energy transfer;

FIG. 18 is a schematic diagram of one bridge leg of a current-source driver; and

FIG. 19 is a diagram showing an integrated inductor structure.

### DETAILED DESCRIPTION OF EMBODIMENTS

For the purpose of this description, the term “MOSFET” will be used as a non-limiting example for all switching devices. It will be understood that other suitable devices, such as, for example, IGBT (insulated gate bipolar transistor), or MCT (MOS controlled thyristor) may also be used. As used herein, the term “gate” refers generally to the input or control terminal of such a switching device.

### A.1. ZVS Self-Driven Non-Isolated Full Bridge Converter

FIG. 1 shows a ZVS self-driven non-isolated full bridge (FB) converter according to one embodiment. In the circuit, Q₁-Q₄ are control MOSFETs and they form a full bridge topology. Q₅-Q₆ are SR MOSFETs. Tᵣ is a power transformer and n is the turns ratio.

In this circuit asymmetrical control is used for each leg of the FB structure to achieve ZVS, instead of the traditional phase-shift (PS) control for isolated FB converters, so that the desired drive signals for SRs can be obtained. Relative to a conventional isolated FB converter, the primary side of this embodiment shares the same ground as the secondary side, which provides the gate drive current path for the SRs.

The mid point A of the first leg of the full bridge (see FIG. 1) is connected to the gate of synchronous MOSFET Q₆, and the midpoint B of the second leg is connected to the gate of synchronous MOSFET Q₅, to drive the SRs as current-source drivers. This configuration provides gate energy recovery and permit use of a high drive voltage with low R_{ds(on)}. Additionally, this configuration reduces the body diode conduction loss and provides a fast switching transition time.

### A.2. Principle of Operation

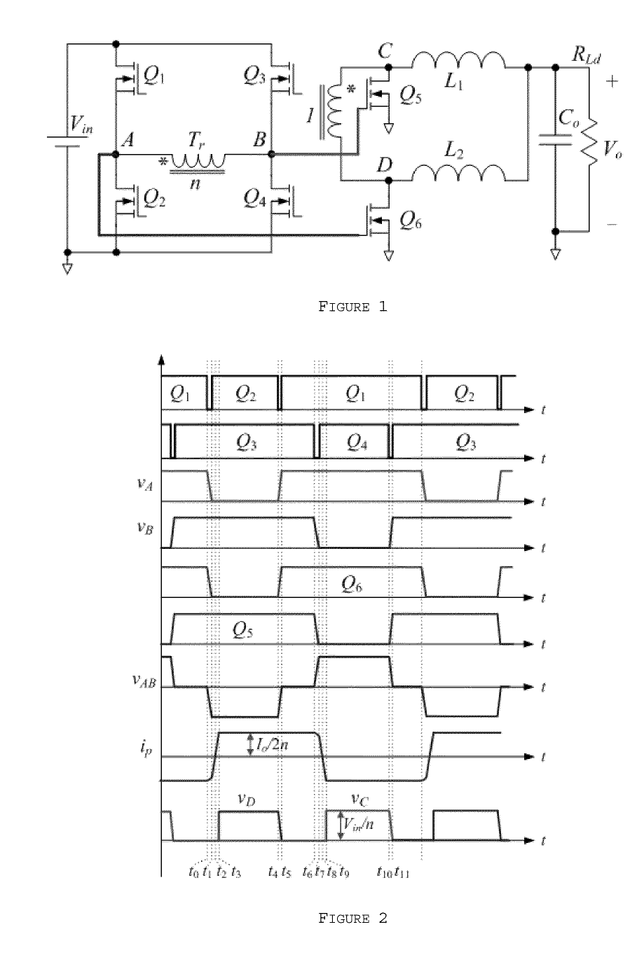

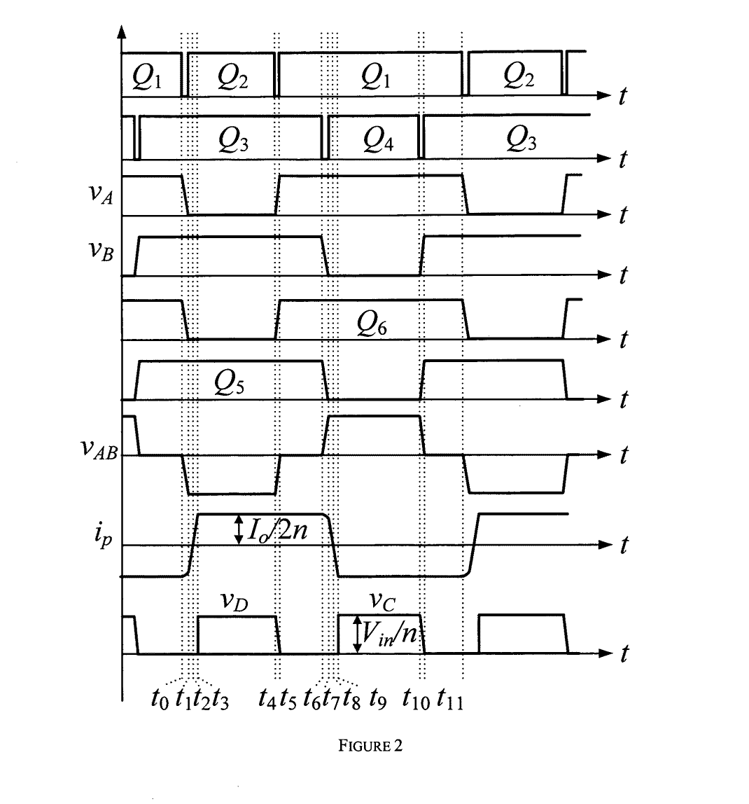

Key waveforms of the embodiment of FIG. 1 are shown in FIG. 2. For the waveforms it will be appreciated that with asymmetrical control for each leg, Q₁ and Q₂, and Q₂ and Q₄ are controlled complementarily with the dead time set to achieve ZVS. Due to the asymmetrical control, the signals of the mid point A and B may be used to drive the SR MOSFETs Q₅ and Q₆ directly, so that the body diode conduction loss is reduced.

### A.3 Features of the ZVS Self-Driven Non-Isolated Full Bridge Converter

Based on the principle of operation, features of the ZVS self-driven non-isolated full bridge converter include:

1) Extension of the Duty Cycle of the Buck Converter

According to the voltage gain of Equation (1), to achieve Vᵢₙ=12V, and Vₒ=1.2V, n=6, the required duty cycle is D=0.5.

$${V}_{o} = \frac{{V}_{in}}{n} \cdot D \qquad ( 1 )$$

In Equation (1), Vᵢₙ is the input voltage, D is the duty cycle of Q₂ and equals Tₒₙ_{_{—}}_{Q2}/(Tₛ/2), where Tₛ is the switching period, Vₒ is the output voltage and n is the transformer turns ratio.

However, for the same output voltage and input voltage, the duty cycle of a conventional buck converter is only 0.1. Therefore, in this embodiment the duty cycle is extended by 5 times, which leads to better current ripple cancellation so that smaller output inductors with lower conduction losses may be used. This also helps to improve the dynamic response of the converter.

2) ZVS of the Control MOSFETs with Low Voltage Stress

For a buck converter, the switching loss of the control MOSFET is expressed as

$${P}_{Q 1} = \frac{1}{2} \cdot {V}_{in} \cdot {I}_{( on ) \_ Q 1} \cdot {t}_{sw ( on ) \_ Q 1} \cdot {f}_{s} + \frac{1}{2} \cdot {V}_{in} \cdot {I}_{( off ) \_ Q 1} \cdot {t}_{sw ( off ) \_ Q 1} \cdot {f}_{s} \qquad ( 2 )$$

where I₍ₒₙ₎_{_{—}}_{Q1} and I_{(off)}_{_{—}}_{Q1} are the turn-off currents, t_{sw(on)}_{_{—}}_{Q1} is the turn-on time, and t_{sw(off)}_{_{—}}_{Q1} is the turn-off time.

For a converter according to the embodiment of FIG. 1, due to the asymmetrical control used to achieve ZVS, there is no turn-on loss. The turn-off loss is expressed as

$${P}_{Q 1} = \frac{1}{n} \cdot \frac{1}{2} \cdot {V}_{in} \cdot {I}_{( off ) \_ Q 1} \cdot {t}_{sw ( off ) \_ Q 1} \cdot {f}_{s} \qquad ( 3 )$$

In an embodiment, with n=3, at least 80% of the total switching loss is saved, which makes the circuit suitable for use in the MHz range. As a specific example, for a conventional two phase buck converter where Vᵢₙ=12 V, Vₒ=1.2 V, switching frequency=1 MHz, output inductance L_{f}=300 nH, total output current Iₒ=60 A, the turn-off current of each control MOSFET is 35 A and the total turn-off current is 70 A. However, for the embodiment of FIG. 1, the turn-off current of each control MOSFET is only 10 A and the total turn-off current is 40 A (a reduction of 43%), which results in a significant reduction of turn-off losses due to the duty cycle extension.

For a conventional buck converter, due to the reverse recovery of the body diode and variation of the input voltage, the peak voltage of the switching node with ringing is more than 20 V and therefore, MOSFETs rated at 30 V are generally used for the control MOSFETs. However, in the embodiment of FIG. 1, the voltage stress of the control MOSFETs is only the input voltage (12 V, typically), so 20V MOSFETs that usually have lower R_{ds(on)} may be used to reduce the conduction losses.

3) Self-Driven with Gate Energy Recovery and Reduced Body Diode Conduction

In the embodiment of FIG. 1, the SR MOSFETs Q₅ and Q₆ are self-driven, so no drive circuitry or ICs are needed. This represents a significant saving in the cost of the converter. Further, the inherent adaptive drive control for the SRs means that no additional dead time control circuit is required. Also, with self-driven control, the dead time is minimized inherently, which reduces significantly the body diode conduction loss. It is noted that the self-driven circuit forms a current-source driver by using the leakage inductance of the transformer to ensure the fast turn-on and turn-off transition of the SRs and to recover the gate energy at the same, which is critical at MHz switching frequencies, and provides a high drive voltage (input voltage, usually 12 V) for synchronous MOSFETs (e.g., MOSFETs with lower R_{ds(on)}) to further reduce conduction losses.

4) Reduced Reverse Recovery Loss and Conduction Loss of SRs

Similar to the control MOSFETs, MOSFETs rated at 30 V are generally used for the SRs in conventional buck converters. However, due to the duty cycle extension provided by the embodiment of FIG. 1, the voltage stresses of the synchronous MOSFETs, including ringing, are reduced to less than 10 V when n=3. So MOSFETs rated at 10 V or 20 V with lower R_{ds(on)} may be chosen to further reduce the conduction loss, though the gate charge may increase. However, the energy may be recovered by the self-driven current-source driver.

5) Design Compatible with Current VR Technology

Another feature of this embodiment is that since the control MOSFETs are in the legs of the FB structure, low cost commercial high-side and low-side drive ICs may be directly used to drive these switches without additional circuitry. No special control and design for the SR driver of the secondary-side, such as additional drive windings or external drive ICs, are required. Also, the design process of this embodiment is straight-forward and similar to that of a traditional FB converter, which is familiar to most design engineers. Therefore, less design effort is required, which results in a quick time to market in commercial applications.

Overall, the ZVS self-driven non-isolated FB converter of this embodiment significantly reduces frequency-dependent losses including switching loss, reverse recovery loss, and gate drive loss of SRs in a cost-effective manner. This embodiment also reduces voltage stress of the control MOSFETs and synchronous MOSFETs and improves the dynamic response of the converter owing to the duty-cycle extension. A significant efficiency improvement will be provided by this embodiment.

B.1. Improved ZVS Self-Driven Non-Isolated Full-Bridge Voltage Regulator with Reduced Gate Drive Voltage

From the analysis of the last section, it will be appreciated that a self-driven non-isolated full-bridge VR as described herein has significant advantages over a conventional buck converter. However, the gate drive voltage of the SR MOSFETs reaches the input voltage (usually 12 V), which might not be the optimal gate drive voltage of the SRs since the R_{ds(on)} of the SRs usually does not decrease substantially when the gate drive voltage is over about 7 V.

In certain applications such as notebook computers where the input voltage is around 19 V, this voltage is too high to drive the SR MOSFETs and may cause excessive gate drive loss, and may also approach or exceed the maximum gate voltage rating for MOSFETs having ratings of around 20 V. At the same time, one of the features of the embodiments described herein is that MOSFETs with low voltage ratings (e.g., <12 V), with lower R_{ds(on)}, may be used for the SRs to reduce conduction loss.

Such low voltage (e.g., 12 V) SRs may only sustain less than 10 V gate drive voltage. Therefore, an input voltage of 12 V is not suitable to drive such low voltage SRs. In this section, embodiments of a ZVS self-driven full bridge VR with reduced gate drive voltage are described, which may resolve the above-mentioned issues.

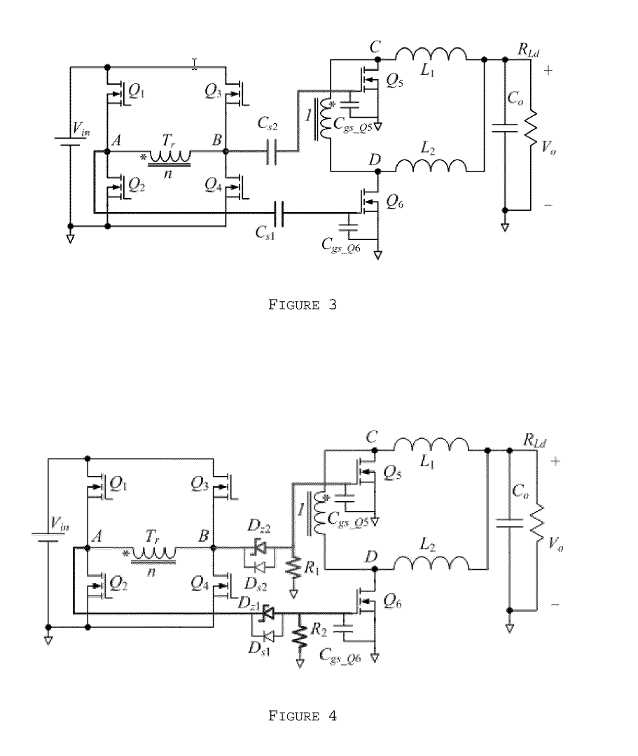

FIG. 3 shows an embodiment of a VR with reduced gate drive voltage using series capacitors Cs1 and Cs2. Cgs_Q5 and Cgs_Q6 are the intrinsic gate capacitances of SRs Q5 and Q6. As used herein, the term “gate capacitance” or “gate capacitor” means the capacitance that exists between the gate and source terminals of the switching device. The gate capacitance is part of the switching device and is not equivalent to stray capacitance that may exist elsewhere in a circuit.

The principle of operation is similar to the embodiment of FIG. 1. In this embodiment, because of the series capacitors Cₛ₁ and Cₛ₂ as capacitor voltage dividers, the voltage across the gate capacitances C_{gs}_{_{—}}_{Q5} and C_{gs}_{_{—}}_{Q6} is reduced to less than the input voltage. The voltage is determined by the ratio of the series capacitors and the gate capacitances of the SRs.

It will be appreciated that other techniques may also be used in accordance with this embodiment to achieve the effect of the gate voltage reduction capacitors in FIG. 3. For example, other devices (e.g., inductors, semiconductors) or combinations thereof may be used. FIG. 4 shows such an embodiment of a VR with reduced gate drive voltage using zener diodes. Dₛ₁ and Dₛ₂ are the zener diodes, which are in series with the inherent gate capacitances of Q₅ and Q₆, C_{gs}_{_{—}}_{Q5} and C_{gs}_{_{—}}_{Q6}. R₁ and R₂ are resistors connected in parallel with C_{gs}_{_{—}}_{Q5} and C_{gs}_{_{—}}_{Q6}. Here the zener diodes create a voltage against the drive voltage so that the actual gate voltage applied to the SR MOSFETs is the input voltage (Vᵢₙ) minus the voltage V_{z} across the zener diodes. It is also noted that after the gate drive voltage reaches Vᵢₙ-V_{z}, there is no gate current in the drive path. In addition, two schottky diodes Dₛ₁ and Dₛ₂ may optionally be connected in parallel with the zener diodes as shown in FIG. 4 to improve the efficiency of gate energy recovery.

A feature of the embodiments of FIGS. 3 and 4 is that the gate voltage may be chosen for optimal design and safe operation when the input voltage value is not suitable to drive the SRs directly, due to either low gate voltage ratings of the SRs or a high input voltage.

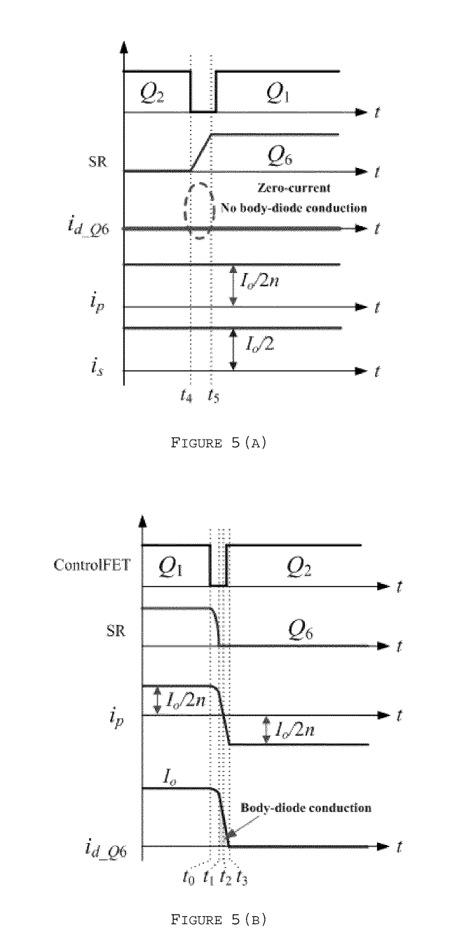

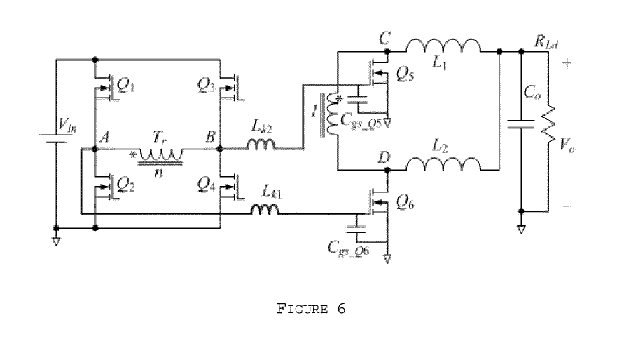

FIGS. 5(A) and 5(B) show key waveforms of the turn-on transition and the turn-off transition, respectively, of the SR MOSFET Q₆ of the embodiment of FIG. 1. In the below analysis of the circuit operation, the output capacitor Cₒ is ignored since Cₒ is much smaller than the gate capacitance C_{gs}_{_{—}}_{Q6} of the SR Q₆.

For the turn-on transition [t₄, t₅] of SR Q₆, the primary current iₚ is the reflected current from the load and charges C_{gs}_{_{—}}_{Q6} linearly until v_{gs}_{_{—}}_{Q6} reaches the input voltage at t₅, which turns SR Q₆ on. The primary side of the transformer is clamped at zero-state and iₚ equals Iₒ/2n. Though SR Q₆ turns on before t₆, the drain current of Q₆ remains zero during the zero-state. Therefore, there is no body-diode conduction for the turn-on transition of the SR MOSFETs as shown in FIG. 5(A). It is interesting to observe that a short time turn-on delay of the SR MOSFETs (typically 20 ns to 30 ns) will not result in any conduction of the body-diode.

For the turn-off transition [t₀, t₁] of SR Q₆, at t₀, Q₁ turns off and the leakage inductance Lₖ starts to resonate with the capacitance C_{gs}_{_{—}}_{Q6} until v_{gs}_{_{—}}_{Q6} reaches zero at t₁, which turns SR Q₆ off. The current through Q₆ then transfers to the body diode until iₚ changes its polarity and reaches the load current of Iₒ/2n at t₃. Therefore, the current as shown during [t₁, t₃] in FIG. 5(B) passes through the body diode of Q₆.

The forward voltage drop of the body diode will result in high conduction loss with high circulating currents. Furthermore, the high forward current through body diode also results in high reverse recovery charge and thus high reverse recovery loss. This loss may be reduced by minimizing the conduction time of the body diode. This may be achieved as follows:

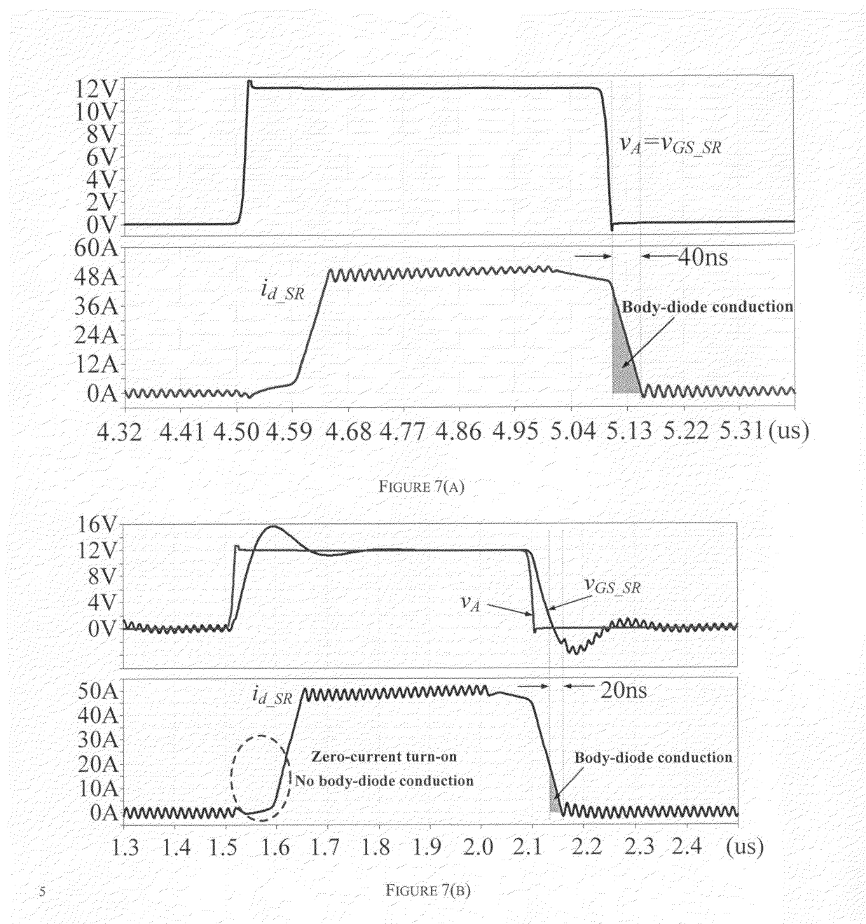

The ideal SR turn-off waveform is, when i_{d}_{_{—}}_{Q6} reaches zero, the SR then turns off. Based on this, the turn-off gate drive signal of the SRs is delayed. In one embodiment, this is achieved using a small inductor (e.g., 30 nH-100 nH air core inductor at 1 MHz switching frequency) in series with the gate of the SR MOSFETs so that the gate drive voltage of the SR is still sustained when the voltage of the midpoints (A and B) reaches zero. FIG. 6 shows an embodiment of a circuit to achieve the above concept, with inductors Lₖ₁ and Lₖ₂. Though the delay circuit will also lead to a turn on delay of the SRs, due to zero current turn-on of the SRs, this delay will not result in any significant body diode conduction. FIG. 7 shows simulation results comparing reduction of the body diode conduction time without (FIG. 7(A)) and with (FIG. 7(B)) Lₖ₁ and Lₖ₂ (Vᵢₙ=12 V, Vₒ=1.2 V, Iₒ=50 A, fₛ=1 MHz, Lₖ₁=Lₖ₂=100 nH). It is observed that the actual gate drive signal is delayed by 20 ns from the midpoint voltage v_{A}, which reduces the body diode conduction significantly as shown in the shaded area. At the same time, zero-current turn-on of the SR is achieved.

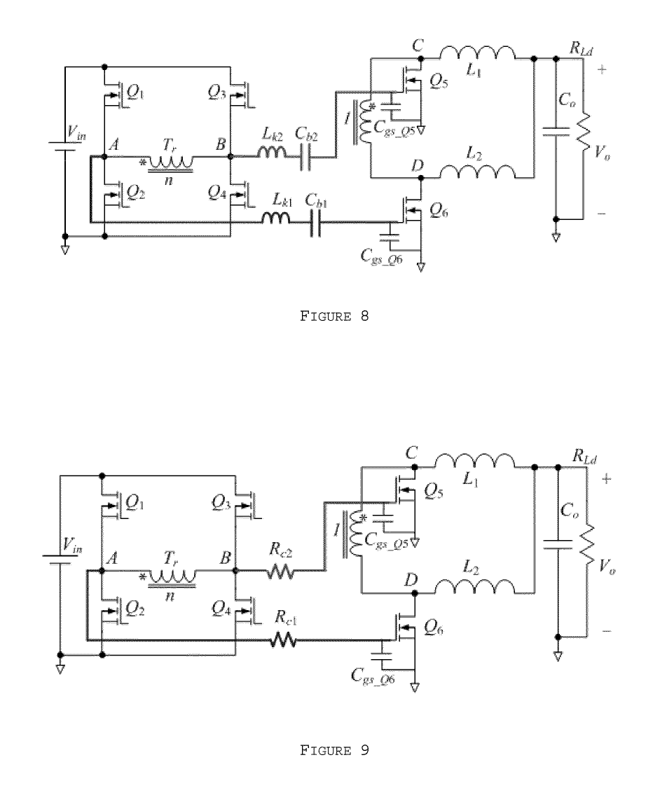

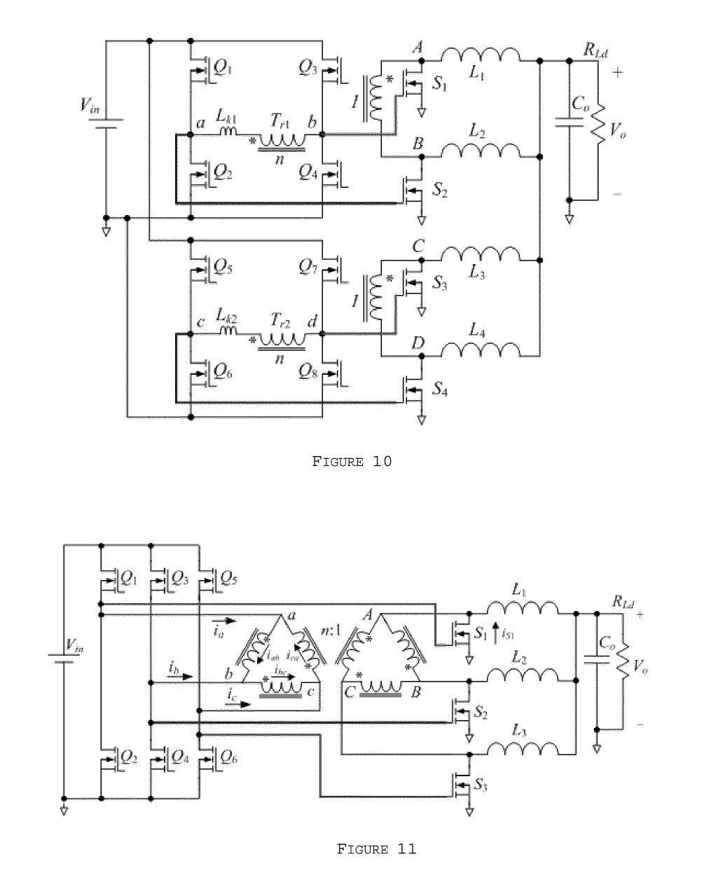

In a further embodiment, the inductors Lₖ₁ and Lₖ₂ may be combined with series capacitors Cₛ₁ and Cₛ₂ as shown in FIG. 8 to achieve both reduced gate drive voltage and reduced body diode time. FIG. 9 shows another embodiment in which resistors R_{c1} and R_{c2} are used to achieve both reduced gate drive voltage and reduced body diode conduction time.

### C.1. Multiphase Interleaving Non-Isolated ZVS Self-Driven FB Converters

With the increasingly higher current demand of microprocessors, the output current of VRs exceeds 100 A and may reach 150 A in the near future. To meet this high current requirement, multiphase buck converters are widely used as the solution for current VR architecture. However, as mentioned above, the buck converter has low efficiency due to the high turn-off loss at high frequency (>1 MHz).

To provide high output current (>100 A), non-isolated ZVS self-driven full bridge converters as described herein may be connected in parallel as shown in the embodiment of FIG. 10. The gate drive control signals for each bridge may be interleaved to achieve a ripple cancellation effect. All the features of the non-isolated ZVS self-driven full bridge converter discussed above are preserved in this structure. Of course, interleaved converters may be provided with more than two converter circuits connected in parallel, where required.

Loss analysis revealed that since the switching loss is significantly reduced, the SR conduction loss is the dominant loss. Therefore, further multiphase interleaved non-isolated converter embodiments in which the SR conduction loss is significantly reduced are described below. These embodiments preserve all the features of the embodiments described above.

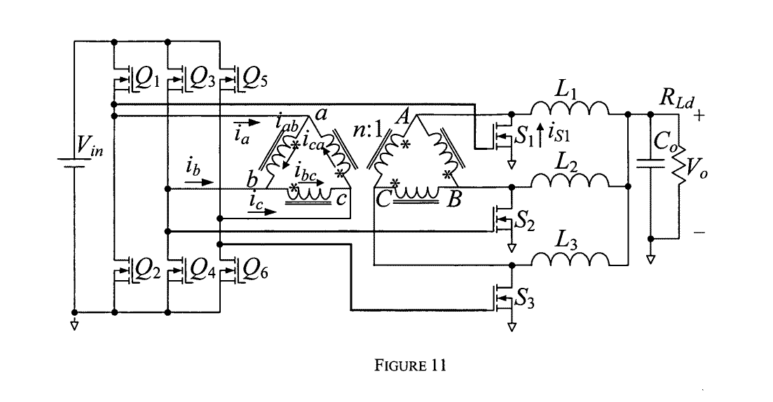

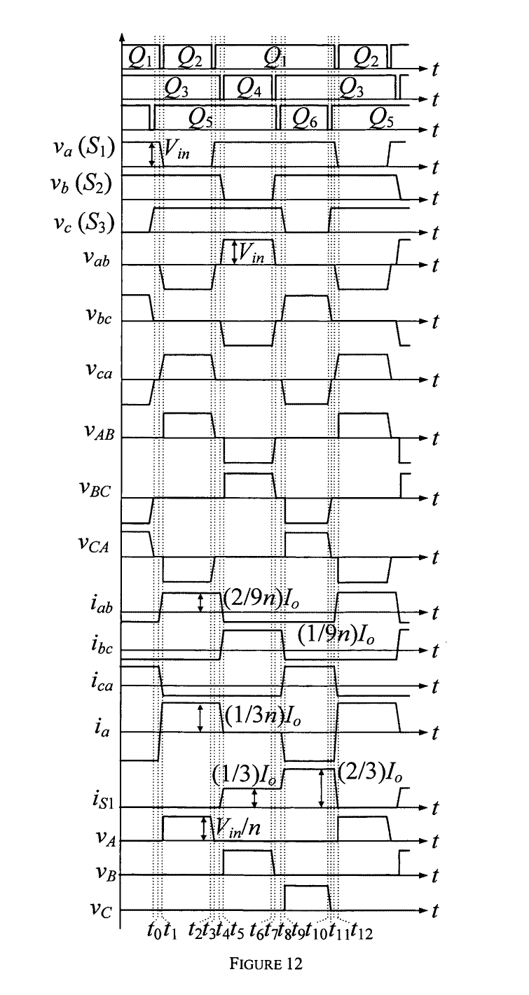

FIG. 11 shows an embodiment of a three phase non-isolated ZVS self-driven full bridge converter with a current tripler rectifier. Key waveforms are shown in FIG. 12. In this embodiment, a three-phase transformer (turns ratio n) with a delta connection is used. The connection points A, B, and C (see FIG. 11) of the secondary side of the transformer are connected to the output inductors individually to form a multiphase structure. A feature of this embodiment is that the RMS currents of the SR MOSFETs and transformer windings are significantly reduced compared to the two parallel non-isolated ZVS self-driven full bridge converter of FIG. 10. This reduces conduction losses of the SR MOSFETs and windings significantly, especially in high current applications. Compared to the current doubler rectifier, the freewheeling load currents are shared by two SR MOSFETs rather than one SR MOSFET, which reduces the current RMS value significantly.

From the waveform of i_{S1} in FIG. 12, the RMS current of the SR MOSFET S₁ with the current tripler is

$${I}_{S 1 \_RMS} = \sqrt{\frac{1}{3} \cdot {( \frac{{I}_{o}}{3} )}^{2} + \frac{1}{3} \cdot {( \frac{2 {I}_{o}}{3} )}^{2}} = \frac{\sqrt{15}}{9} {I}_{o} \qquad ( 4 )$$

The RMS value of the secondary winding current with the current tripler is

$${I}_{Sec\_RMS} = \sqrt{\frac{1}{3} \cdot {( \frac{2 {I}_{o}}{9} )}^{2} + \frac{2}{3} \cdot {( \frac{{I}_{o}}{9} )}^{2}} = \frac{\sqrt{2}}{9} {I}_{o} \qquad ( 5 )$$

The RMS current of the SR MOSFET S₁ of the current doubler in FIG. 10 is

$${I}_{S 1 \_RMS} = \sqrt{\frac{1}{2}} \cdot {I}_{o} \qquad ( 6 )$$

The RMS value of the secondary winding current with current doubler is

$${I}_{Sec\_RMS} = \frac{{I}_{o}}{2} \qquad ( 7 )$$

For example, Vₒ=1.0 V and Iₒ=120 A. To make a fair comparison, each phase is assumed to provide 20 A. So three ZVS self-driven full bridge VR converters are required in parallel as a module. According to Equation (6), the RMS current of each SR MOSFET is 28.3 A. Assuming the R_{DS(on)} of the SR MOSFET is 1.6 mohm, the total SR conduction loss is 7.7 W (I_{RMS}² R_{DS(on)}). Similarly, for the three-phase non-isolated ZVS self-driven full bridge converter in FIG. 11, two converters are connected in parallel to power the load. According to Equation (4), the RMS current of each SR MOSFET is 25.8 A, so the total conduction loss of the SR MOSFETs is 6.4 W. This leads to SR loss reduction of 1.3 W, which is a reduction of 17% (1.3 W/7.7 W) of the total SR loss and 1.1% of the output power (1.3 W/1.0 V/120 A).

For the high current secondary winding loss, the RMS current with the current tripler is 9.4 A from Equation (5) and the RMS current of the secondary winding is 20 A from Equation (7). This leads to a total secondary winding loss reduction of 55.8% (1-9.4² 6 R_{ac}/20² 3 R_{ac}), assuming the same secondary winding AC resistance R_{ac}.

Although three transformers are shown in FIG. 11, due to the interleaving control of the control MOSFETs, the magnetic field in each core is 120 degrees phase shifted. Therefore, these transformers may be integrated as one transformer by using one magnetic core, which is similar to an AC three-phase transformer. In low voltage and high current applications, printed circuit board (PCB) planar transformers may be used to achieve low resistance and low leakage inductance.

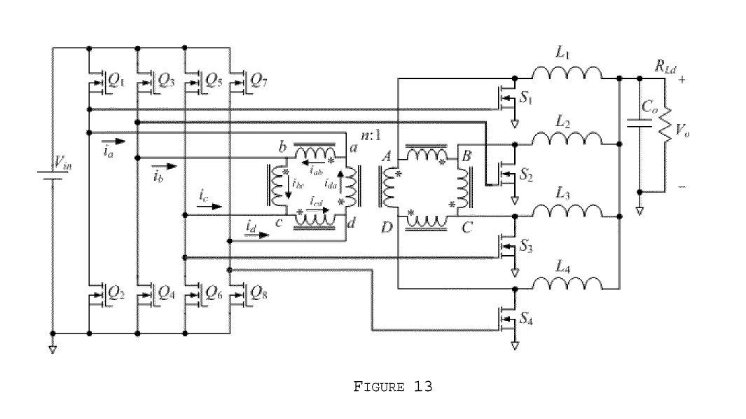

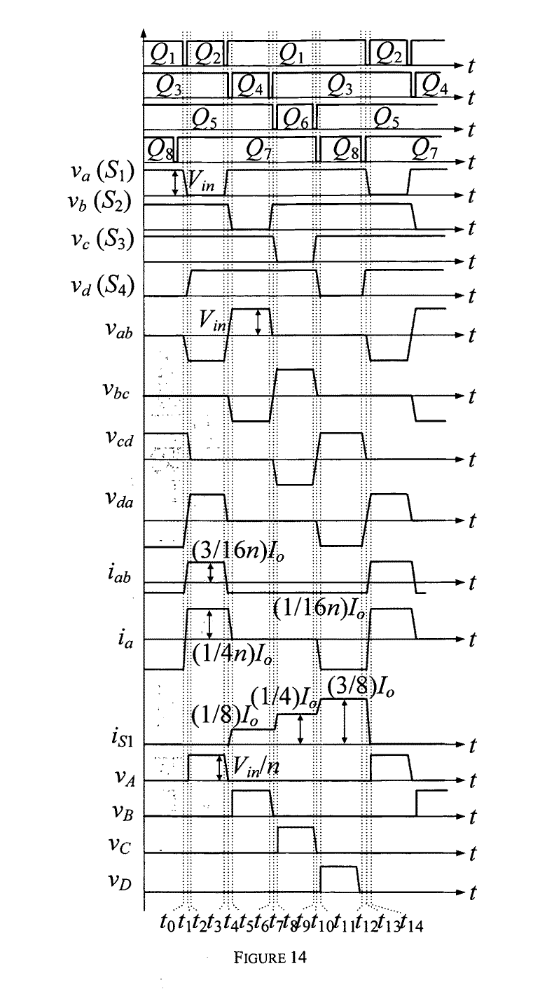

Similarly, a four-phase non-isolated ZVS self-driven FB converter with current quadrupler rectifier may be provided based on the above, as shown in FIG. 13. Key waveforms are shown in FIG. 14. The four transformer structure may use two magnetic cores, using magnetic integration due the magnetic flux cancellation effect.

From the waveform of i_{S1} in FIG. 14, the RMS current of the SR MOSFET S₁ of the four phase non-isolated ZVS self-driven FB converters is

$${I}_{S 1 \_RMS} = \sqrt{\frac{1}{4} {( \frac{{I}_{o}}{8} )}^{2} + \frac{1}{4} {( \frac{{I}_{o}}{4} )}^{2} + \frac{1}{4} {( \frac{3 {I}_{o}}{8} )}^{2}} = \frac{\sqrt{14}}{16} {I}_{o} \qquad ( 8 )$$

The RMS value of the secondary winding current with the current quadrupler is

$${I}_{Sec\_RMS} = \sqrt{\frac{1}{4} \cdot {( \frac{3 {I}_{o}}{16} )}^{2} + \frac{3}{4} \cdot {( \frac{{I}_{o}}{16} )}^{2}} = \frac{\sqrt{3}}{16} {I}_{o} \qquad ( 9 )$$

For example, for Vₒ=1.0 V and Iₒ=100 A, to make a fair comparison, each phase is assumed to provide 25 A. Two ZVS self-driven FB VR converters with current doubler rectifier are required, in parallel as a module. According to Equation (6), the RMS current of each SR MOSFET is 35.4 A. Assuming the R_{DS(on)} of the SR MOSFET is 1.6 mohm, the total SR conduction loss is 8.0 W (I_{RMS}² R_{DS(on)}*4). For the four-phase non-isolated ZVS self-driven FB converter with current quadrupler rectifier of FIG. 13, two converters are connected in parallel to power the load. According to Equation (8), the RMS current of each SR MOSFET is 23.4 A. The total conduction loss of the SR MOSFETs is 3.5 W (I_{RMS}² R_{DS(on)}*4). This leads to a significant SR loss reduction of 4.5 W, which is a reduction of 56.3% (4.5 W/8.0 W) of the total SR loss and 4.5% of the output power (4.5 W/1.0 V/120 A).

For the high current secondary winding loss, the RMS current of the secondary winding with the current quadrupler is 10.8 A, from Equation (9), and the RMS current of the secondary winding with the current doubler is 25 A, from Equation (7). This leads to a total secondary winding loss reduction of 62.7% (1-10.8²*4 R_{ac}/25²*2 R_{ac}), assuming the same secondary winding AC resistance R_{ac}.

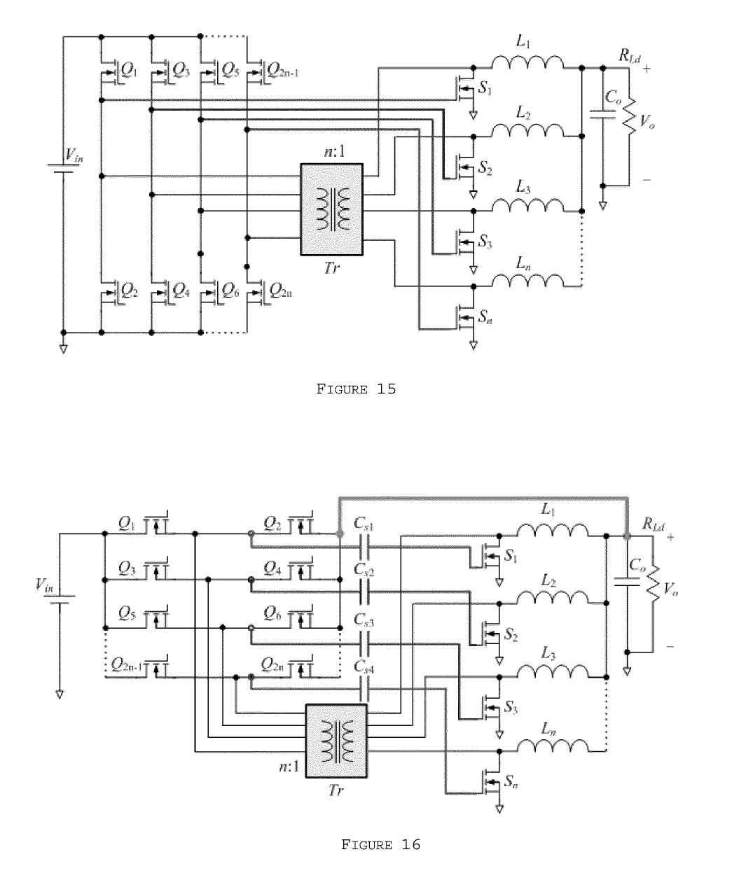

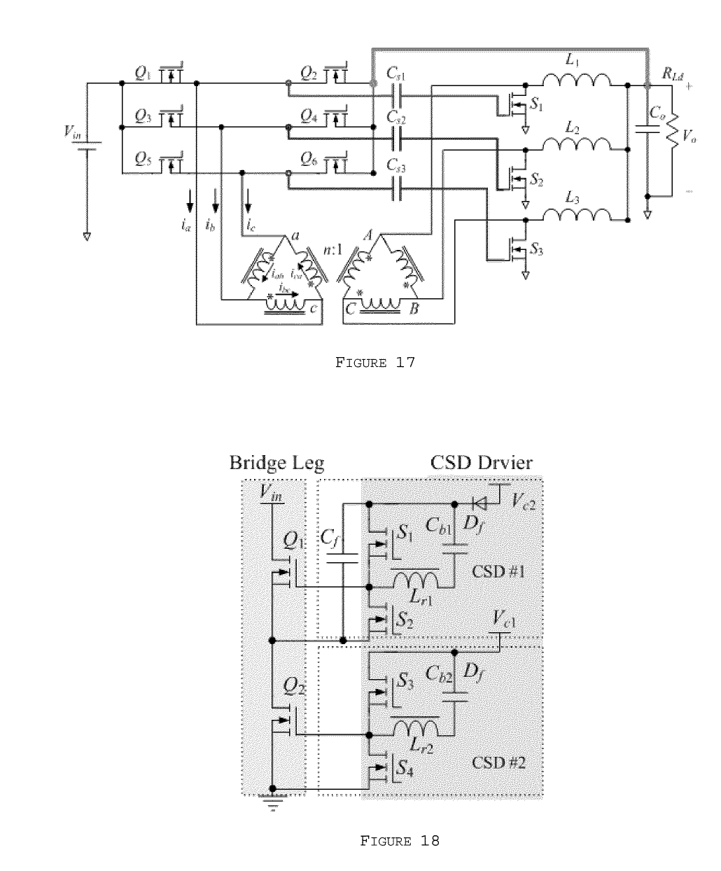

Further embodiments of n-phase non-isolated ZVS self-driven FB converters with multiple stage rectifiers may also be produced, as shown in FIG. 15, to provide high output currents. Furthermore, to reduce the current stress of the SR MOSFET and the transfer winding, and reduce the total conduction loss, n-phase non-isolated ZVS self-driven FB converters with multiple stage rectifiers and direct energy transfer may be provided as shown in the embodiments of FIG. 16 and FIG. 17. In such embodiments, gate series capacitors (Cₛ₁, Cₛ₂, Cₛ₃, etc.) may be included to achieve desired self-driven gate drive signals for the SR MOSFETs. These embodiments retain all the features of the above embodiments (see, e.g., FIG. 15). In particular, for three phase embodiments, a current tripler may be used for the rectifier stage, and for the four phase embodiment, a current quadrupler may be used for the rectifier stage.

### D. Current-Source Gate Driver

In the above embodiments there is no turn-on loss due to ZVS, and the turn-off loss is reduced significantly by the factor of turns ratio n. However, the turn-off loss is still the dominant loss in the total loss breakdown. It would be expected to be even higher above 2 MHz switching frequency due to parasitic inductance in the PCB traces and packaging. In addition, there are four control MOSFETs, which contributes to gate driver losses above 2 MHz switching frequency.

To push the switching frequency above 2 MHz, a current-source gate drive circuit may be used to drive four MOSFETs in a ZVS self-driven full bridge topology to further reduce turn-off loss due to parasitics and achieve gate energy recovery above 2 MHz. FIG. 18 shows an embodiment of such a current-source gate drive circuit with two control MOSFETs in one bride leg.

The current-source gate driver reduces the turn-off loss due to parasitics, which is the dominant loss for a MOSFET with ZVS capability. Due to the energy recovery feature of the current-source gate driver, the gate voltage of the control MOSFETs may be higher, e.g., 8 V-12 V, which also leads to a reduction of the R_{ds(on)} conduction losses.

A current-source drive circuit as described herein has the following features: 1) gate energy recovery; 2) reduction in switching loss due to the parasitic inductance; 3) ZVS of all the driver switches; and 4) high noise immunity and alleviation of the dv/dt effect.

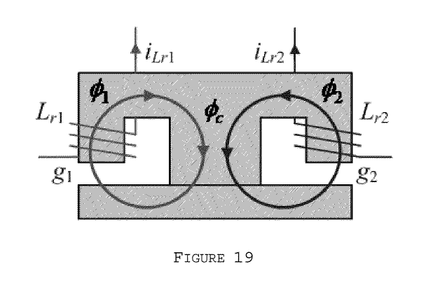

In addition, to minimize the component count and reduce the circuit footprint, the two resonant inductors (Lᵣ₁ and Lᵣ₂) may be integrated. FIG. 19 shows one integrated inductor structure for such current-source driver circuits.

### E. Applications of ZVS Self-Driven Full Bridge Converter

A ZVS self-driven non-isolated full bridge converter as described herein may be used for an input voltage VR (e.g., 12 V) without isolation requirements for server computers and desktop computers, for high efficiency for computer servers. One state of the art approach for a 48 V VR is a two-stage power conversion. The first stage achieves isolation with an unregulated dc-to-dc converter with high efficiency, while the second stage achieves output voltage regulation to power microprocessors with MHz switching frequency, non-isolated dc-to-dc converters, called core converters. The converters described herein are suitable for such second stage converters to achieve high efficiency, high frequency, and fast dynamic response and high power density. Another application is for second stage converters of input voltage power VRs (e.g., 48 V)

The ZVS converters described herein may also be used for notebook computer VRs. In this application the input voltage of the VR is typically 19 V-21 V. Multi-phase buck converters usually cannot handle this input voltage well because the duty-cycle will be as low as 0.06 for an output voltage of 1.2 V. However, the converters described herein are suitable for this application due to the duty-cycle extension of the transformer. Furthermore, the features of ZVS and self-driven capability achieve high efficiency at MHz frequencies, to improve the power density and dynamic response.

All cited publications are incorporated herein by reference in their entirety.

### EQUIVALENTS

Those skilled in the art will recognize, or be able to ascertain using routine experimentation, equivalents to the embodiments described herein. Such equivalents are encompassed by the invention and are covered by the attached claims.

### REFERENCES

[1] Voltage Regulator Module (VRM) and Enterprise Voltage Regulator-Down (EVRD), Std. 10.1 Design Guidelines, March 2005.
[2] L. Huber, K. Hsu, M. M. Jovanovic, D. J. Solley, G. Gurov and R. M. Porter, “1.8-MHz, 48-V resonant VRM: analysis, design, and performance evaluation,” IEEE Trans. Power Electron., Vol. 21, No. 1, pp. 79-88, January 2006.
[3] A. Ball, D. Sterk and F. C. Lee, “The combination of thermal and electrical improvements in a 1U 100A VRM,” in Proc. IEEE PESC, 2007, pp. 15-20.
[4] M. Xu, Y. Ying, Q. Li and F. C. Lee, “Novel coupled-inductor multi-phase VRs,” in Proc. IEEE APEC, 2007, pp. 113-119.
[5] J. Sun, J. Lu, D. Giuliano, T. P. Chow and R. J. Gutmann, “3D Power Delivery for Microprocessors and High-Performance ASICs,” in Proc. IEEE APEC, 2007, pp. 127-133.
[6] Y. Ren, M. Xu, J. Zhou and F. C. Lee, “Analytical loss model of power MOSFET,” IEEE Trans. Power Electron., vol. 21, no. 2, pp. 310-319, March 2004.
[7] Z. Zhang, W. Eberle, Z. Yang, Y. F. Liu and P. C. Sen, “Optimal design of current source gate driver for a buck voltage regulator based on a new analytical loss model,” in Proc. IEEE PESC, 2007, pp. 1556-1562.
[8] W. Eberle, Z. Zhang, Y. F. Liu and P. C. Sen, “A high efficiency synchronous buck VRM with current source gate driver,” in Proc. IEEE PESC, 2007, pp. 21-27.
[9] K. Yao, M. Ye, M. Xu and F. C. Lee, “Tapped-inductor buck converter for high-step-down DC-DC conversion,” IEEE Trans. Power Electron., vol. 20, no. 4, pp. 775-780, July 2005.
[10] M. Batarseh, X. Wang and I. Batarseh, “Non-isolated half bridge buck based converter for VRM application,” in Proc. IEEE PESC, 2007, pp. 2393-2398.
[11] Z. Yang, S. Ye and Y. F. Liu, “A novel non-isolated half bridge DC-DC converter”, IEEE Applied Power Electronics Conference (APEC), 2005, pp. 301-307.
[12] K. Yao, Y. Ren, J. Wei, M. Xu and F. C. Lee, “A family of buck-type DC-DC converters with autotransformer,” in Proc. IEEE APEC, 2003, pp. 114-120.
[13] J. Wei and F. C. Lee, “Two novel soft-switched, high frequency, high-efficiency, non-isolated Voltage Regulators—the phase-shift buck converter and the matrix-transformer phase-buck converter,” IEEE Transactions on Power Electronics, Vol. 20, No. 2, March 2005, pp. 292-299. regulator for future microprocessors,” IEEE Trans. Power Electron., vol. 20, no. 4, pp. 806-814, July 2005.
[14] M. Xu, Fred C. Lee and J. Zhou, “Bridge-buck converter with self-driven synchronous rectifiers,” U.S. Pat. No. 6,859,372, Feb. 22, 2005.
[15] M. Xu, Y. Ren, J. Zhou and Fred C. Lee, “1-MHz self-driven ZVS full-bridge converter for 48-V power pod and DC/DC brick,” IEEE Trans. Power Electron., Vol. 20, No. 6, September 2005, pp. 997-1006.
[16] M. Xu, J. Zhou and Fred C. Lee, “A current-tripler dc/dc converter,” IEEE Trans. Power Electron., Vol. 19, No. 3, May 2004, pp. 693-700.
[17] J. Zhou, M. Xu; J. Sun and F. C. Lee, “A self-driven soft-switching voltage

1. A voltage regulator, comprising:
a control stage including one or more primary windings of at least one transformer and plurality of control switches connected in a full bridge configuration; and
a rectifier stage comprising a current multiplier including one or more secondary windings of the at least one transformer and plurality of rectifier switches;
wherein output points of the control stage are connected together through one or more primary windings of the at least one transformer;
wherein output points of the rectifier switches are connected together through one or more secondary windings of the at least one transformer.

2. The voltage regulator of claim 1, wherein each output point of the control stage is connected directly to a gate of a rectifier switch.

3. The voltage regulator of claim 1, wherein each output point of the control stage is connected to a device, and the device is connected to a gate of a rectifier switch.

4. The voltage regulator of claim 3, wherein each device is selected from a capacitor, an inductor, a diode, a zener diode, a schottky diode, a resistor, and a combination thereof.

5. The voltage regulator of claim 1, wherein the transformer has one primary winding and one secondary winding, and the current multiplier is a current doubler.

6. The voltage regulator of claim 1, including one transformer having three primary windings and three secondary windings, and the current multiplier is a current tripler.

7. The voltage regulator of claim 1, including three transformers, each transformer having a primary winding and a secondary winding, and the current multiplier is a current tripler.

8. The voltage regulator of claim 1, including one transformer having four primary windings and four secondary windings, and the current multiplier is a current quadrupler.

9. The voltage regulator of claim 1, including four transformers, each transformer having a primary winding and a secondary winding, and the current multiplier is a current quadrupler.

10. A current-source gate drive circuit for driving first and second control switches of a full bridge leg, comprising:
(A) a first input terminal for receiving an input voltage;
a first switch and a second switch connected in series at a first node;
a diode having a first terminal connected to the input terminal and a second terminal connected to the drain of the first switch;
a series circuit including a first inductor and a first capacitor connected between the first node and the second terminal of the diode; and
a third capacitor connected in parallel with the first switch and the second switch;
wherein a source of the second switch is connected to a point between the first control switch and the second control switch, and the first node is connected to the gate of the first control switch; and
(B) a second input terminal for receiving an input voltage;
a third switch and a fourth switch connected in series at a second node, a drain of the third switch being connected to the second input terminal;
a series circuit including a second inductor and a second capacitor connected between the second node and the second input terminal;
wherein a source of the fourth switch is connected to circuit ground, and the second node is connected to the gate of the second control switch.

11. The current-source gate drive circuit of claim 10, wherein the first inductor and the second inductor are integrated.

12. The voltage regulator of claim 1, further comprising the current-source gate drive circuit of claim 10 for one or more legs of the full bridge.

13. A method of operating a voltage regulator, comprising:
connecting a plurality of control switches in a full bridge configuration with one or more primary windings of at least one transformer in a control stage;
providing a rectifier stage comprising a current multiplier including one or more secondary windings of the at least one transformer and plurality of rectifier switches;
connecting output points of the control stage together through one or more primary windings of the at least one transformer; and
connecting output points of the rectifier switches together through one or more secondary windings of the at least one transformer.

14. The method of claim 13, comprising connecting each output point of the control stage directly to a gate of a rectifier switch.

15. The method of claim 13, comprising connecting each output point of the control stage to a device, and connecting the device to the gate of a rectifier switch.

16. The method of claim 13, wherein each device is selected from a capacitor, an inductor, a diode, a zener diode, a schottky diode, a resistor, and a combination thereof.

17. The method of claim 13, comprising operating each leg of the full bridge of the control stage with asymmetrical control.

18. The method of claim 13, comprising operating at least one leg of the full bridge as a current-source driver to drive the rectifier switches.

19. The method of claim 18, comprising using leakage inductance of the transformer to operate the current source driver.
